(19) United States
(12) Patent Application Publication
(10) Pub. No.: US 2025/0108763 A1
(43) Pub. Date: Apr. 3, 2025

(54) System for rotatably mounting a covering panel for a motor vehicle luggage compartment

(71) Applicant: TREVES PRODUCTS,SERVICES & INNOVATION, Paris (FR)

(72) Inventors: Xavier BONFILS, Paris (FR); Eric BRILLON, Paris (FR)

(21) Appl. No.: 18/711,625

(22) PCT Filed: Nov. 18, 2022
(86) PCT No.: PCT/EP2022/082504

§ 371 Date: May 20, 2024

(30) Foreign Application Priority Data
Nov. 19, 2021 (FR) FR2112279

(51) Int. Cl. B60R 5/04; E05D 7/10

(52) U.S. Cl. CPC B60R 5/044; E05D 7/1077

(57) ABSTRACT

System for rotatably mounting a covering panel (2) for a motor vehicle luggage compartment on a trim (3), said system comprising two devices (4) for rotatably slotting said panel, each of said devices comprising: a finger (5) and a receiver (6) for slotting said finger, said finger having a recess (7) provided with a first opening (8), the system further comprising a cavity (9), said receiver being mounted in said cavity, said first opening leading into a second opening (10) provided in said cavity and having an upper wall (11), a bottom wall (12) and a middle wall (13), a decoupling means (14) made of elastically compressible material extending between said receiver and said upper and lower walls, an air gap (15) being provided between said receiver and said middle wall.

The invention concerns a system for rotatably mounting a covering panel for a motor vehicle luggage compartment on a trim of said compartment, and an assembly comprising a trim and a panel mounted thereon by such a system.

A system for rotatably mounting a covering panel for a motor vehicle luggage compartment on a trim of said compartment is known, said system comprising two devices for rotatably slotting said panel, each of said devices comprising:
a transverse finger secured with said panel—or respectively with said trim,
a slotting receiver for said finger, secured with said trim—or respectively with said panel—said receiver having a recess for receiving said finger in close contact, said recess being provided with a first opening that is horizontally accessible, so that said panel can be mounted by horizontal translation.

This system enables the panel to be raised from its horizontal covering position to a raised position for accessing luggage.

It may be desirable to equip the panel with at least one electrodynamic transducer to ensure the transmission of an electrical signal, for example from a radio device or a disc player.

This is achieved by transforming an electrical signal into an acoustic signal, using the wall of the panel as a radiating surface.

However, a system as described hereinabove does not allow the panel to vibrate in a preferred vertical direction—i.e. perpendicular to the horizontal plane in which it generally lies—which corresponds to a suspension mode in which the panel undergoes no deformation (rigid body mode).

The aim of the invention is to provide an improved system for ensuring such vibration, while preserving the ergonomic mounting of the panel and its decoupling for limiting the transmission of vibrations to the rest of the vehicle, and in particular to the seat backrests and the trims of the luggage compartment.

To this end, and according to a first aspect, the invention proposes a system for rotatably mounting a covering panel for a motor vehicle luggage compartment on a trim of said compartment, said system comprising two devices for rotatably slotting said panel, each of said devices comprising:
a transverse finger secured with said panel—or respectively with said trim,
a slotting receiver for said finger, secured with said trim—or respectively with said panel—said receiver having a recess for receiving said finger in close contact, said recess being provided with a first opening that is horizontally accessible so that said shelf can be mounted by horizontal translation,
the system also has the following features:
it further comprises a cavity provided in said trim—or respectively in said shelf—, said receiver being mounted in said cavity, said first opening leading into a second opening provided in said cavity, said cavity having an upper wall, a lower wall and a middle wall connecting them,
it further comprises a decoupling means made of elastically compressible material extending between said receiver and said upper and lower walls,
an air gap is provided between said receiver and said middle wall.

In this description, the terms used for positioning in space (top, bottom, upper, lower, longitudinal, transverse, lateral, front, rear, vertical, horizontal, etc.) refer to the system in place in the vehicle.

With the proposed arrangement:
the presence of the decoupling means between the receiver and the upper and lower walls allows the panel to vibrate vertically (bending waves),
the presence of the air gap ensures on one hand that this vertical vibration is not hindered, and on the other hand that the ergonomics for mounting the panel are not impaired; indeed, under the effect of the thrust exerted on the panel to achieve its slotting, the movement of the receiver in relation to the middle wall cannot exceed the dimension corresponding to the thickness of the air gap; this thickness—chosen, for example, to be less than 1.5 mm—corresponds to the maximum overstroke that the panel can perform in relation to its nominal position during its mounting; by choosing a sufficiently low thickness, the user slotting the panel is not confronted with the impression of “pushing in a vacuum”; moreover, the presence of the air gap prevents the transmission of vibrations in a horizontal plane.

According to a second aspect, the invention proposes an assembly comprising a trim and a panel mounted thereon by such a system.

Further features and advantages of the invention will become apparent from the following description, made with reference to the attached figures, in which:

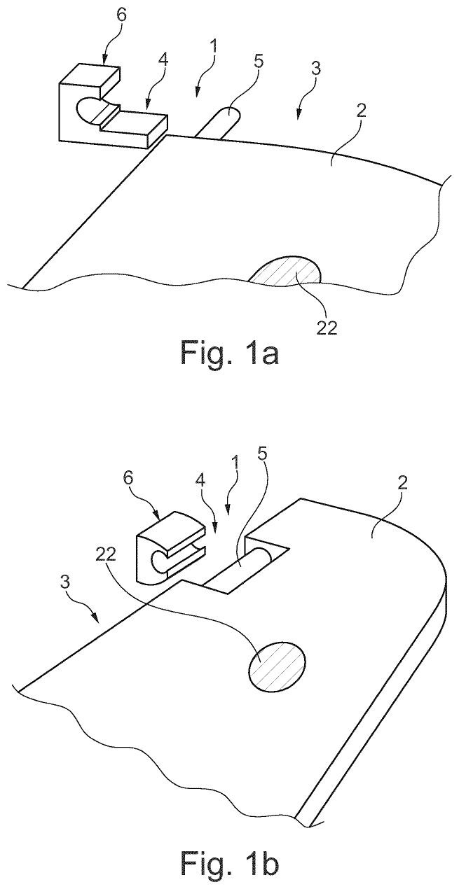

FIG. 1a and

FIG. 1b are schematic partial perspective views of an assembly according to a respective embodiment of the invention, with the panel removed from the trim,

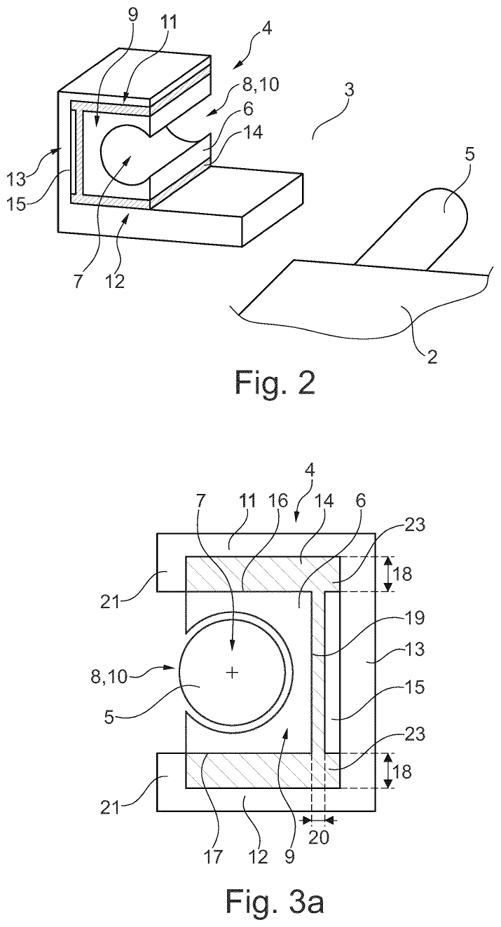

FIG. 2 is a schematic perspective detail view of a slotting device as shown in FIG. 1a,

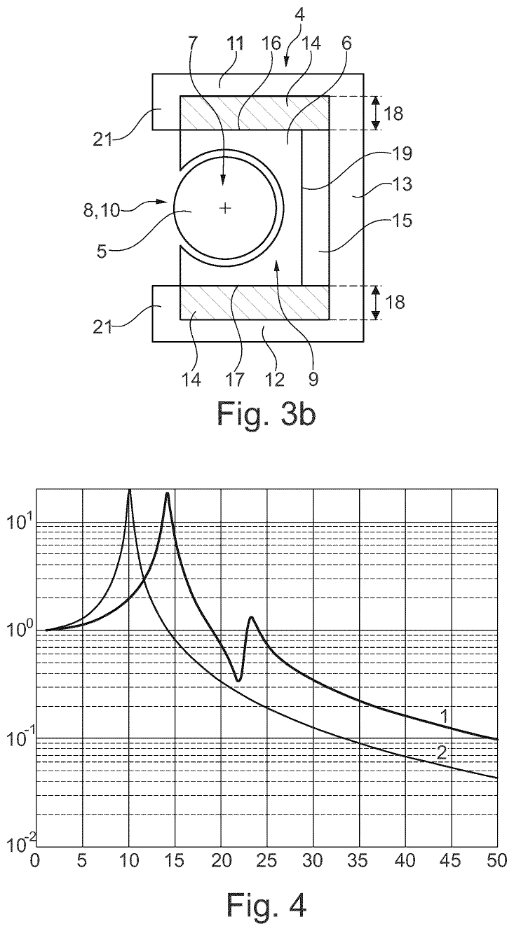

FIG. 3a and

FIG. 3b are schematic longitudinal sectional views of a device according to a respective embodiment of the invention, FIG. 3a corresponding to FIG. 2,

FIG. 4 shows the vibration transmissibility (i.e. the ratio between upstream vibrations—at the panel—and downstream vibrations—at the trim) as a function of frequency (in Hertz) of a device as shown in FIG. 3b (curve 2), compared with an analogous device with no air gap (curve 1).

With reference to the figures, we describe a system 1 for rotatably mounting a covering panel 2 for a motor vehicle luggage compartment on a trim 3 of said compartment, said system comprising two devices 4 for rotatably slotting said panel, each of said devices comprising:
a transverse finger 5 secured with said panel, as shown in FIGS. 1a and 1b—or respectively with said trim, as not shown,
a receiver (6) for slotting said finger, said receiver being secured with said trim, as shown in FIGS. 1a and 1b—or respectively with said panel, as not shown—said receiver having a recess (7) for receiving said finger in closed contact, said recess being provided with a first opening (8) that is horizontally accessible so that said panel can be mounted by horizontal translation,
the system also having the following features:
it further comprises a cavity 9 provided in said trim, as shown in FIGS. 1a and 1b—or respectively in said panel, as not shown —, said receiver being mounted in said cavity, said first opening leading into a second opening 10 provided in said cavity, said cavity having an upper wall 11, a lower wall 12 and a middle wall 13 connecting them,
it further comprises a decoupling means 14 made of elastically compressible material extending between said receiver and said upper and lower walls,
an air gap 15 is provided between said receiver and said middle wall.

As shown in FIG. 3a, the decoupling means 14 also extends between the receiver 6 and the middle wall 13, with the air gap 15 located between said means and said wall.

The extension of the decoupling means 14 opposite the middle wall 13 ensures that the receiver 6 does not come into contact with the middle wall 13 during the mounting of the panel 2, thus avoiding unwanted noise.

In one embodiment, the decoupling means 14 is based on an elastomer material.

The elastomer material is particularly thermoplastic elastomer (TPE), such as polyolefin (TPO), polystyrene (TPS), polyurethane (TPU) or vulcanized thermoplastic (TPV), the choice of the material depending on the requirements.

According to one embodiment, the decoupling means 14 has the following features:
its hardness, measured according to the ISO 868 standard in force at the date of application, is between 25 and 90 shore A,
and/or its compression set (C.S.S.), measured in accordance with ISO 815 standard in force at the date of application, is less than 40%, measured at a temperature of 23° C., after 24 hours of deformation.

In one embodiment, the air gap 15 has a minimum thickness of 0.5 mm.

In one embodiment, the air gap 15 has a maximum thickness of 2 mm.

According to the embodiments shown:
the upper 11 and lower 12 walls lie in horizontal planes, the receiver 6 having upper 16 and lower 17 external faces parallel to said upper and lower walls, the decoupling means 14 having at the top and bottom a same first thickness 18,
the middle wall 13 lies in a vertical plane, and the receiver 6 also has a middle outer face 19 parallel to said middle wall.

According to one embodiment, the first thickness 18 is comprised between 2 and 5 mm, the choice of a sufficient thickness being necessary to allow adequate vertical vibration of the panel 2.

In the embodiment shown in FIG. 3a, the decoupling means 14 has a second thickness 20 facing the middle wall 13, which is less than the first thickness 18.

In one embodiment, the second thickness 20 is comprised between 0.5 and 2 mm, so as to minimize deflection of the receiver 6 when mounting the panel 2, and thus to optimize mounting ergonomics.

According to the embodiments shown, the recess 7 has a generally C-shaped cross-section, the opening of which—corresponding to the first opening 8—can be elastically enlarged—the receiver 6 being in particular made of molded plastic material—so as to enable the finger 5 to be forcibly inserted and held in said recess once said opening has returned to its undeformed state.

According to the embodiments shown, the second opening 10 is delimited at the top and bottom by two returns 21 coming respectively from the upper 11 and lower 12 walls, said returns forming stops for preventing the extraction of the decoupling means 14 from the cavity 9.

As shown in FIG. 3b, the receiver 6 is set back from the decoupling means 14 facing the middle wall 13, said means bearing against said wall and said receiver while being spaced from it so as to define the air gap 15.

As shown in FIG. 3a, the decoupling means 14 has two projections 23 resting on the top and bottom of the middle wall 13, with the air gap 15 extending between said projections.

Finally, with reference to FIGS. 1a and 1b, we describe an assembly comprising a trim 3 and a panel 2 mounted thereon by such a system, said panel being provided with an electrodynamic transducer 22.

In the embodiment shown in FIG. 1a, the fingers 5 are secured with the front corners of the panel 2 and the receivers 6 are secured with the lateral parts of the trim 3 of the luggage compartment.

In the embodiment shown in FIG. 1b, the fingers 5 are secured with the rear edge of the panel 2 and the receivers 6 are secured with the rear part of the trim 3 of the luggage compartment, said part being arranged on the vehicle tailgate.

According to embodiments not shown, in the embodiments of FIGS. 1a and 1b, it may be possible to interchange the positioning of the fingers 5 and the receivers 6, i.e. to position said fingers on the trim 3 and said receivers on the panel 2.

We now comment on the curves in FIG. 4.

It can be seen that decoupling is improved by the presence of the air gap 15, as the first resonance frequency is shifted towards the low frequencies and vibration transmission is reduced earlier in the high frequencies (with a factor greater than 2 at 50 Hz).

It should also be noted that the decoupling means 14, as shown in FIG. 3a, also extends between the receiver 6 and the middle wall 13, resulting in acoustic behavior similar to that of FIG. 3b.

1. System (1) for rotatably mounting a covering panel (2) for a motor vehicle luggage compartment on a trim (3) of said compartment, said system comprising two devices (4) for rotatably slotting said panel, each of said devices comprising:
a transverse finger (5) secured with said panel—or respectively with said trim—respectively,
a receiver (6) for said finger which is secured with said trim—or respectively with said panel
said receiver having a recess (7) for receiving said finger in close contact, said recess being provided with a first opening (8) that is horizontally accessible so that said panel can be mounted by horizontal translation,
the system also having the following features:
it further comprises a cavity (9) provided in said trim—or respectively in said panel—, said receiver being mounted in said cavity, said first opening leading into a second opening (10) provided in said cavity, said cavity having an upper wall (11), a lower wall (12) and a middle wall (13) connecting them,
it further comprises a decoupling means (14) made of elastically compressible material extending between said receiver and said upper and lower walls,
an air gap (15) is provided between said receiver and said middle wall.

2. System according to claim 1, characterized in that the decoupling means (14) further extends between the receiver (6) and the middle wall (13), the air gap (15) being located between said means and said wall.

3. System according to claim 1, characterized in that the decoupling means (14) is based on elastomer material.

4. System according to claim 1, characterized in that the air gap (15) has a minimum thickness of 0.5 mm.

5. System according to claim 1, characterized in that:
the upper (11) and lower (12) walls lie in horizontal planes, the receiver (6) having upper (16) and lower (17) external faces parallel to said upper and lower walls, the decoupling means (14) having a same first thickness (18) at the top and bottom,
the middle wall (13) lies in a vertical plane, and the receiver (6) also has a middle outer face (19) parallel to said middle wall.

6. A system as claimed in claim 5, when related to claim 2, characterized in that the decoupling means (14) further extends between the receiver (6) and the middle wall (13), the air gap (15) being located between said means and said wall and wherein the decoupling means (14) has a second thickness (20) opposite the middle wall (13) which is less than the first thickness (18).

7. A system according to a claim 1, characterized in that the recess (7) has a generally C-shaped cross-section, the opening of which is elastically enlargeable so as to enable the finger (5) to be forcibly inserted and held in said recess once said opening has returned to its undeformed state.

8. System according to claim 1, characterized in that the second opening (10) is delimited at the top and bottom by two returns (21) coming respectively from the upper (11) and lower (12) walls, said returns forming anti-extraction stops for preventing the extraction of the decoupling means (14) from the cavity (9).

9. Assembly comprising a trim (3) and a panel (2) mounted thereon by a system according to claim 1, said panel being provided with an electrodynamic transducer (22).
